(19) United States
(12) Patent Application Publication
(10) Pub. No.: US 2023/0405475 A1
(43) Pub. Date: Dec. 21, 2023

(54) SHOOTING METHOD, APPARATUS, DEVICE AND MEDIUM BASED ON VIRTUAL REALITY SPACE

(71) Applicant: Beijing Zitiao Network Technology Co., Ltd., Beijing (CN)

(72) Inventors: Peipei WU, Beijing (CN); Xiangyu HUANG, Beijing (CN); Liyue JI, Beijing (CN); Wenhui ZHAO, Beijing (CN); Can WANG, Beijing (CN)

(21) Appl. No.: 18/324,336

(22) Filed: May 26, 2023

(30) Foreign Application Priority Data
Jun. 17, 2022 (CN) 202210693464.X

(51) Int. Cl. A63F 13/837; A63F 13/213; G06F 3/01

(52) U.S. Cl. CPC A63F 13/837; A63F 13/213; G06F 3/012

(57) ABSTRACT

The present disclosed relates to a shooting method, apparatus, device, and medium based on a virtual reality space. The method comprises: in response to a selfie call command, determining a shooting position of a virtual character model that holds a camera model in the virtual reality space, and displaying the virtual reality scene in a preset stage scene model based on the shooting position; displaying real-time viewfinder information in a viewfinder area of the camera model, wherein the real-time viewfinder information comprises a virtual reality scene and a virtual character model within the selfie field of view; in response to the selfie confirmation command, determining the real-time viewfinder information within the viewfinder area as captured image information. In an embodiment of the present disclosures, selfie in virtual space is achieved, the shooting method in virtual space is expanded, and the shooting realism in virtual space is improved.

### CROSS-REFERENCE TO RELATED APPLICATIONS

This application claims priority to and benefits of Chinese Patent Application No. 202210693464.X, filed on Jun. 17, 2022, and entitled “SHOOTING METHOD, APPARATUS, DEVICE, AND MEDIUM BASED ON VIRTUAL REALITY SPACE”, the entire disclosure of which is hereby incorporated by reference.

### TECHNICAL FIELD

This disclosure relates to the field of virtual reality technology, in particular to a shooting method, device, device, and medium based on virtual reality space.

### BACKGROUND

Virtual Reality (VR) technology, also known as virtual environment, spiritual realm, or artificial environment, refers to the use of computers to generate a virtual world that can directly apply visual, auditory, and tactile sensations to participants, and allow them to observe and operate interactively. Improving VR realism to make the experience of virtual reality space similar to that of real physical space has become a mainstream approach.

In related technologies, virtual reality technology can be used to achieve the viewing of live streaming content such as online concerts. In virtual spaces, users can watch concerts similar to real-life live concerts.

However, existing technologies are unable to meet users' selfie needs while watching VR videos, which affects their VR user experience.

### SUMMARY

In order to solve the above technical problems or at least partially solve them, this disclosure provides a shooting method, device, device, and medium based on virtual reality space, with the main purpose of improving the current prior art that cannot meet the user's needs for selfie in virtual reality scenes.

Embodiments of the present disclosure provide a shooting method based on virtual reality space, comprising: in response to a selfie call command, determining a shooting position of a virtual character model that holds the camera model in the virtual reality space, and displaying a virtual reality scene in a preset stage scene model based on the shooting position; displaying real-time viewfinder information within the viewfinder area of the camera model, wherein the real-time viewfinder information comprises a virtual reality scene and a virtual character model within the selfie field of view; and in response to a selfie confirmation command, determining the real-time viewfinder information within the viewfinder area as captured image information.

Embodiments of the present disclosure provide a shooting device based on virtual reality space, comprising: a shooting position determination module for, in response to a selfie call command, determining a shooting position of a virtual character model that holds the camera model in the virtual reality space; a first display module for and displaying a virtual reality scene in a preset stage scene model based on the shooting position; a second display module for displaying real-time viewfinder information within the viewfinder area of the camera model, wherein the real-time viewfinder information comprises a virtual reality scene and a virtual character model within the selfie field of view; and a captured image determination module for, in response to a selfie confirmation command, determining the real-time viewfinder information within the viewfinder area as captured image information.

Embodiments of the present disclosure further provide an electronic device, which includes: a processor; a memory for storing instructions executable by the processor; the processor is configured to read the executable instructions from the memory and execute the executable instructions to implement any of shooting method based on a virtual reality space as described in embodiments of the present disclosure.

Embodiments of the present disclosure also provide a computer-readable storage medium, which stores a computer program for executing the shooting method based on a virtual reality space as described in embodiments of the present disclosure.

The solution provided in embodiments of the present disclosure has the following advantages compared to the prior art.

The shooting scheme based on virtual reality space provided by embodiments of the present disclosure determine the shooting position of the virtual character model holding the camera model in the virtual reality space and displays the virtual reality scene in the preset stage scene model based on the shooting position, in response to the selfie call command. Furthermore, real-time shooting picture information is displayed in the viewfinder area of the camera model, wherein the real-time viewfinder information includes virtual reality scenes and virtual character models within the selfie field of view. In response to the selfie confirmation command, the real-time viewfinder information within the viewfinder area is determined as the captured image information. As a result, selfie in virtual space has been achieved, expanding the shooting methods in virtual space, and improving the realism of shooting in virtual space.

### DESCRIPTION OF THE DRAWINGS

The above and other features, advantages, and aspects of each embodiment of the present disclosure will become more apparent by combining the accompanying drawings and referring to the following specific implementation methods. Throughout the accompanying drawings, identical or similar reference numerals represent identical or similar elements. It should be understood that the attached drawings are illustrative, and the original and elements may not necessarily be drawn to scale.

FIG. 1 is a schematic diagram of an application scenario of a virtual reality device provided in an embodiment of the present disclosure;

FIG. 2 is a flowchart of a shooting method based on virtual reality space provided by an embodiment of the present disclosure;

FIG. 3 is a schematic diagram of the display example effect of an interactive component model in the form of a floating ball provided in an embodiment of the present disclosure;

FIG. 4 is a schematic diagram of a viewing scene based on real space provided by an embodiment of the present disclosure;

FIG. 5 shows a schematic diagram of the display example effect of the camera model provided in an embodiment of the present disclosure;

FIG. 6 is a schematic diagram of a shooting scene based on virtual reality space provided by an embodiment of the present disclosure;

FIG. 7 is a flowchart of another shooting method based on virtual reality space provided by an embodiment of the present disclosure;

FIG. 8 is a schematic diagram of another model structure based on virtual reality space provided by an embodiment of the present disclosure;

FIG. 9 is a display schematic diagram of a virtual reality scene based on a virtual reality space provided by an embodiment of the present disclosure;

FIG. 10 is a schematic diagram of a selfie scene provided by an embodiment of the present disclosure;

FIG. 11 is a structural schematic diagram of a shooting device based on virtual reality space provided in an embodiment of the present disclosure; and

FIG. 12 is a schematic diagram of the structure of an electronic device provided in an embodiment of the present disclosure.

### SPECIFIC EMBODIMENTS

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as limited to the embodiments described here. On the contrary, these embodiments are provided for a more thorough and complete understanding of the present disclosure. It should be understood that the accompanying drawings and embodiments disclosed in this disclosure are only for illustrative purposes and are not intended to limit the scope of protection of this disclosure.

It should be understood that the various steps recorded in the disclosed method implementation can be executed in different orders and/or in parallel. In addition, the method implementation may include additional steps and/or omitting the steps shown for execution. The scope of this disclosure is not limited in this regard.

The term “including” and its variations used in this article are open-ended, meaning “including but not limited to”. The term ‘based on’ refers to ‘at least partially based on’. The term ‘one embodiment’ means ‘at least one embodiment’; The term ‘another embodiment’ means ‘at least one other embodiment’; The term ‘some embodiments’ means ‘at least some embodiments’. The relevant definitions of other terms will be given in the following description.

It should be noted that the concepts such as “first” and “second” mentioned in this disclosure are only used to distinguish different devices, modules or units, and are not intended to limit the order or interdependence of the functions performed by these devices, modules or units.

It should be noted that the modifications of “one” and “multiple” mentioned in this disclosure are indicative rather than restrictive, and those skilled in the art should understand that unless otherwise explicitly stated in the context, they should be understood as “one or more”.

The names of the messages or information exchanged between multiple devices in this disclosed embodiment are for illustrative purposes only and are not intended to limit the scope of these messages or information.

Provide relevant explanations on some technical concepts or noun concepts involved in this article:

Virtual reality devices, terminals that achieve virtual reality effects, can usually be provided in the form of glasses, Head Mount Display (HMD), or contact lenses for visual perception and other forms of perception. Of course, the forms implemented by virtual reality devices are not limited to this and can be further miniaturized or enlarged as needed.

The virtual reality devices recorded in the embodiments of the present invention can include but are not limited to the following types:

Computer based virtual reality (PCVR) devices use the PC to perform related calculations and data output for virtual reality functions, while external computer based virtual reality devices use the data output from the PC to achieve virtual reality effects.

Mobile virtual reality devices support setting up mobile terminals (such as smartphones) in various ways (such as head-mounted displays with dedicated card slots). Through wired or wireless connections with the mobile terminal, the mobile terminal performs virtual reality related calculations and outputs data to the mobile virtual reality device, such as watching virtual reality videos through the mobile terminal's APP.

An all-in-one virtual reality device with a processor for computing related virtual functions, thus having independent virtual reality input and output functions, without the need to connect to a PC or mobile terminal, and with high degrees of freedom of use.

Virtual reality objects, namely, objects that interact in virtual scenes, are controlled by users or robot programs (such as artificial intelligence-based robot programs), and can be stationary, mobile, and engage in various behaviors in virtual scenes, such as virtual humans corresponding to users in live streaming scenes.

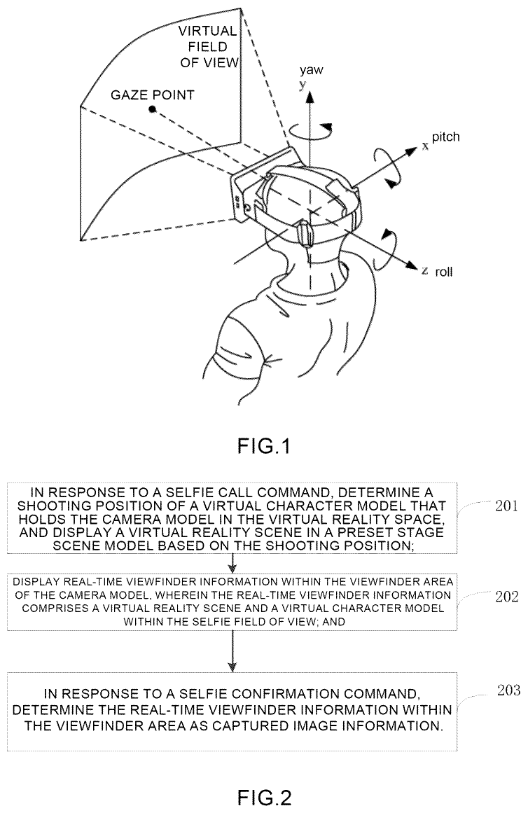

As shown in FIG. 1, HMD is relatively lightweight, ergonomically comfortable, and provides high-resolution content with low latency. The virtual reality device is equipped with pose detection sensors (such as nine axis sensors) for real-time detection of posture changes in the virtual reality device. If a user wears a virtual reality device, when the user's head posture changes, the real-time pose of the head will be transmitted to the processor to calculate the user's gaze point in the virtual environment, thereby computing the image within the user's gaze range (i.e., virtual field of view) in the 3D model of the virtual environment based on the gaze point and displaying it on the display screen, so that an immersive experience that feels like watching in a real environment is created.

In such an embodiment, when a user wears an HMD device and opens a predetermined application, such as a video live streaming application, the HMD device will run the corresponding virtual scene. The virtual scene can be a simulated environment of the real world, a semi simulated and semi fictional virtual scene, or a purely fictional virtual scene. Virtual scenes can be any of two-dimensional, 2.5-dimensional, or 3-dimensional virtual scenes. Embodiments of the present disclosure do not limit the dimensions of virtual scenes. For example, a virtual scene can include characters, sky, land, ocean, etc. The land can include environmental elements such as deserts and cities. Users can control the movement of virtual objects in the virtual scene, and can also interactively control the controls, models, display content, characters, etc. in the virtual scene through methods such as joystick devices and bare hand gestures.

As mentioned above, in virtual reality space, if a user has a need for selfies, for example, when watching a concert in virtual reality space, if they have a need to be in sync with a singer, they cannot be satisfied.

In order to meet the user's selfie needs, embodiments of the present disclosure provide a shooting method based on virtual reality space. The following will introduce this method in conjunction with specific embodiments.

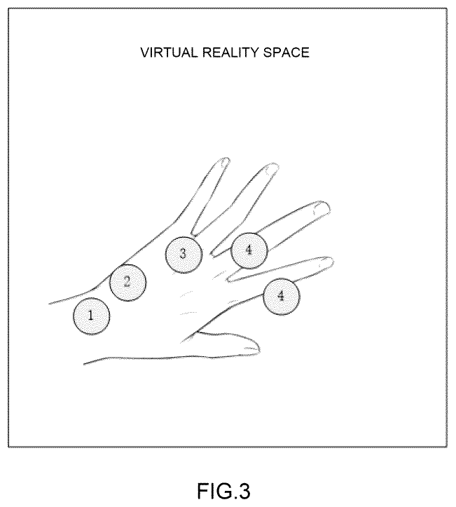

FIG. 2 is a flowchart of a shooting method based on virtual reality space provided by embodiments of the present disclosure. The method can be executed by a shooting device based on virtual reality space, which can be implemented using software and/or hardware and can generally be integrated into electronic devices. As shown in FIG. 2, this method includes:

At step 201, in response to a selfie call command, the shooting position of the virtual character model holding the camera model in the virtual reality space is determined, and the virtual reality scene in the preset stage scene model is displayed based on the shooting position.

The camera model can be visualized and viewed by users wearing the aforementioned virtual reality devices. The camera model is a shooting model displayed in the virtual reality space for indicating that users can use the corresponding camera model for shooting. The camera model can be any model such as a smartphone model or a selfie camera model, and there is no limitation here.

It should be noted that in different application scenarios, the selfie call command can be executed in different ways, as will be explained in the following.

In some possible embodiments, the selfie call command can be used to turn on the selfie function, similar to turning on the selfie function of a camera. For example, the user can trigger the input selfie call command by manipulating the preset buttons on devices such as handheld devices, and then invoke the use of selfie function to experience shooting services.

There are also various alternative ways for the user to input selfie call commands. Compared to using physical device buttons to trigger selfie calls, one possible approach proposes an improvement solution that does not require the use of physical device buttons for VR manipulation, which can improve the technical issues that may affect user control due to the easy damage of physical device buttons.

In this optional approach, the image information captured by the camera on the user can be monitored, and then based on the user's hand or handheld device (such as a handle) in the image information, it can be determined whether it meets the preset conditions of the display interaction component model (the component model used for interaction, and each interaction component model is pre bound with interaction function events). If it is determined that the preset conditions of the display interaction component model is met, at least one interactive component model is displayed in virtual reality space; and, finally, by identifying the action information of the user's hand or handheld device, the interaction function event(s) associated with the selected interactive component model by the user is executed.

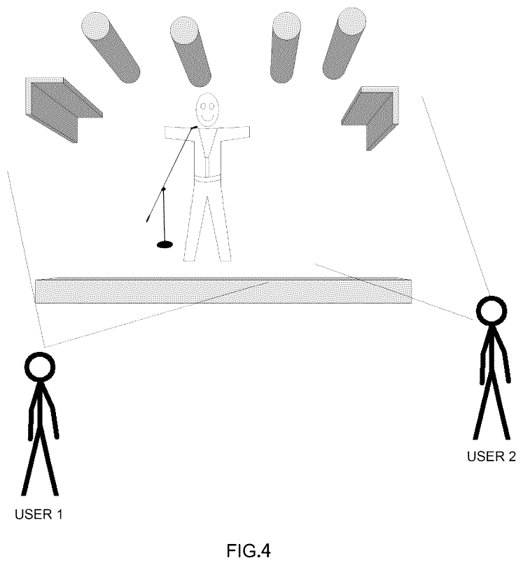

For example, a camera can be used to capture images of a user's hand or handheld device, and based on image recognition technology, the user's hand gestures or handheld device position changes in the image can be determined. If it is determined that the user's hand or handheld device is raised by a certain amount in such a way that the virtual hand or handheld device mapped in the virtual reality space enters the user's current perspective range, the display interaction component model can be invoked in virtual reality space. As shown in FIG. 3, based on image recognition technology, the user can lift the handheld device to invoke interactive component models in the form of floating balls, where each floating ball represents a control function, and users can interact based on the floating ball function. As shown in FIG. 3, these floating balls 1, 2, 3, 4, and 5 can correspond to interactive component models such as “leaving the room”, “shooting”, “selfie”, “barrage”, and “2D live streaming”.

After invoking the interaction component model in the form of a floating ball, based on the subsequent monitoring of the image of the user's hand or user handheld device images, the spatial position of the corresponding click mark is determined by identifying the position of the user's hand or user handheld device and mapping it to virtual reality space. If the spatial position of the click mark matches the spatial position of the target interaction component model displayed in these interaction component models, it is determined that the target interaction component model is the interaction component model selected by the user; finally, the interaction function event associated with the target interaction component model is executed.

The user can raise the handle on his left hand to invoke an interactive component model in the form of a floating ball, and then select and click on the interactive component by moving the position of the handle on his right hand. On the VR device side, based on the image of the user's handle, the position of the right-hand handle is identified and mapped to the virtual reality space to determine the spatial position of the corresponding click sign. If the spatial position of the click sign matches the spatial position of the interaction component model of the “selfie”, the user chooses to click on the “selfie” function; finally, the interaction function event associated with the “selfie” interaction component model is executed, i.e., the selfie function is triggered.

In an embodiment of the present disclosure, in response to the selfie call command, the shooting position of the virtual character model holding the camera model in the virtual reality space is determined, indicating the position of the virtual character model in the virtual reality space. The virtual character model is a virtual character model that maps characters in reality, and the specific model form of the virtual character model can be set according to the requirements of the scene. There are no restrictions here.

It is to be understood that in real-life scenarios, the viewing experience varies depending on the user's location. For example, as shown in FIG. 4, if a user watches a concert in real-life space, the viewing experience varies depending on the location.

Therefore, in order to enhance the viewing realism and simulate the display of virtual reality scenes, in embodiments of the present disclosure, the virtual reality scene is also displayed in the preset stage scene model based on the shooting position of the virtual character model in the virtual reality space. The preset stage scene model can be considered as a model built in the virtual reality space for displaying concert and live streaming images, Virtual reality scenes can be considered as concert models or live streaming footage. In such embodiments, the virtual reality scene displayed in the preset stage scene model is related to the shooting position of the pseudo character model in the virtual reality space.

At step 202, real-time viewfinder information is displayed in the viewfinder area of the camera model, real-time viewfinder information comprising virtual reality scenes and virtual character models within the selfie field of view.

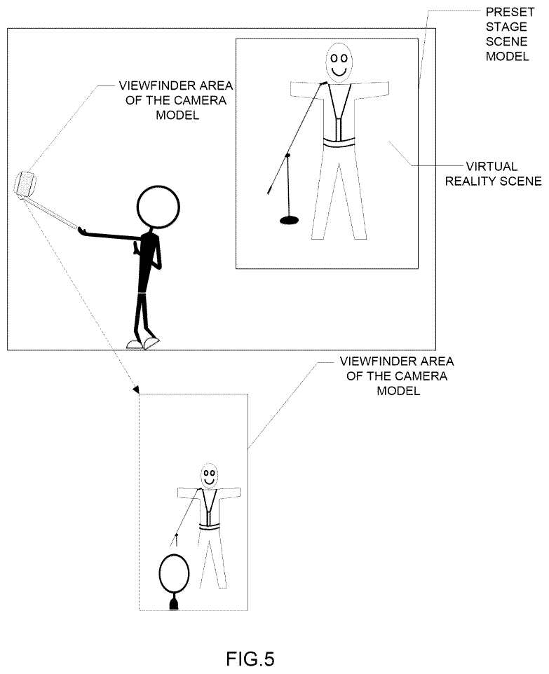

In an embodiment of the present disclosure, in order to enhance the realism of shooting in virtual reality space, the camera model also includes a viewfinder area. For example, as shown in FIG. 5, if the camera model is a selfie stick model, the corresponding selfie stick model has a viewfinder area displayed on the front side.

In this embodiment, the real-time viewfinder information is displayed in the viewfinder area of the camera model. The real-time viewfinder information includes virtual reality scenes and virtual character models within the selfie field of view. As the real-time viewfinder information includes virtual reality scenes and virtual character models within the selfie field of view, it meets the user's selfie needs.

At step 203, in response to the selfie confirmation command, the real-time viewfinder information in the viewfinder area is determined as the captured image information.

In an embodiment disclosed in the present disclosure, in response to the selfie confirmation command, it is determined that the real-time viewfinder information within the viewfinder area is captured image information. The captured image information can comprise: selfie photo information (i.e., image information) or selfie video information (i.e., recorded video information).

In this embodiment, the determination of the selfie confirmation command can refer to the determination of the selfie call command as discussed above and will not be repeated here.

Therefore, in embodiments of the present disclosure, by displaying real-time viewfinder information in the viewfinder area of the camera model, the user has an intuitive experience of shooting in virtual reality space. By determining the real-time viewfinder information in the viewfinder area as the captured image information, the acquisition of selfie image information is achieved, meeting the needs of selfie in virtual reality space.

For example, in virtual reality space, if the virtual reality scene is a concert scene, users can achieve the corresponding virtual character model and concert scene synchronization through the above shooting method. For this embodiment, in order to achieve a more realistic shooting effect, in some possible embodiments, relevant prompt information in the recording can be output in the selfie recording mode, or a picture with a flashing effect can be displayed in the viewfinder area. After confirming the captured image information, a prompt message indicating successful recording can be output.

For example, for video recording services, text or icon information representing the recording can be displayed during the recording process, and voice prompts during the recording can also be output together. For photography services, when users click to take a photo, a blank transition image can be quickly displayed in the viewfinder area and then quickly switched back to the texture information, thereby creating a flickering effect and increasing the user's closer to real shooting experience. After taking a successful photo, it can prompt that the photo taken has been saved successfully and display the saved directory of the photo.

Furthermore, in order for the user to share the captured photos or videos, after obtaining the captured image information, this embodiment may further comprise: in response to a sharing command, sharing the captured image information to a target platform (such as a social platform, where users or other users can access the captured image information), or sharing the captured image information with the specified users in the contact list through the server (such as sharing it with the user's designated friends through the server), or sharing with users corresponding to other virtual objects in the same virtual reality space.

For example, the user can view other users currently entering the same room, and then select one of them to share the captured image information with them; Alternatively, by selecting other virtual objects in the same VR scene through user focus, joystick rays, and other methods, the system can share the captured image information with the virtual object. Based on the identification of the virtual object, the system can find the corresponding target user and forward the shared captured image information to the target user, achieving the purpose of sharing photos or videos.

In order to provide users with a more realistic VR experience, in some possible embodiments, the camera model used for shooting other virtual objects is displayed in the same virtual reality space. For example, in the VR scene of a live concert, there is a need for people to take photos of the live VR scene, or there is a need for selfies between several virtual characters. Therefore, when shooting other virtual objects, the camera model used can be displayed. In the VR scene of a live concert, there are three virtual objects, namely virtual object a, virtual object b, and virtual object c, which correspond to three users entering the same room. When the system detects the shooting of virtual object a, it can synchronously display the camera model used by virtual object a to virtual object b and virtual object c, allowing the two users, virtual object b and virtual object c, to intuitively understand that virtual object a is currently shooting. And in order to present a more realistic feeling, the system can also synchronize the slice information within the viewfinder area of the camera model (such as the texture maps rendered for the VR scene within the selected shooting range for virtual object a) to the user side of virtual object b and virtual object c. In this way, you can experience a more realistic VR experience when multiple people (virtual objects) selfie.

In order to avoid display conflicts caused by multiple people lifting the camera model at the same time, it is optional to display the camera model used by other virtual objects when shooting in the same virtual reality space. In the same virtual reality space, the camera model of one's own virtual object and the camera model of other virtual objects are displayed according to their respective separate spatial positions. For example, the camera models of each virtual object in the same virtual reality space have their own corresponding individual spatial positions, which do not affect each other, and there will be no problem of camera model display conflicts.

Compared with the prior art, the embodiments can provide users with selfie services during the viewing process of virtual reality scenes, such as photography services or video recording services, enabling users in virtual reality environments to experience the feeling of using a camera to selfie in a real environment, improving their VR user experience.

In summary, the shooting method based on virtual reality space in embodiments of the present disclosure determines the shooting position of the virtual character model holding the camera model in the virtual reality space in response to the selfie call command, and displays the virtual reality scene in the preset stage scene model based on the shooting position. Furthermore, in the viewfinder area of the camera model, real-time viewfinder information is displayed, wherein the real-time viewfinder information includes virtual reality scenes and virtual character models within the selfie field of view. In response to the selfie confirmation command, the real-time viewfinder information within the viewfinder area is determined as the captured image information. As a result, selfie in virtual space has been achieved, expanding the shooting methods in virtual space, and improving the realism of shooting in virtual space.

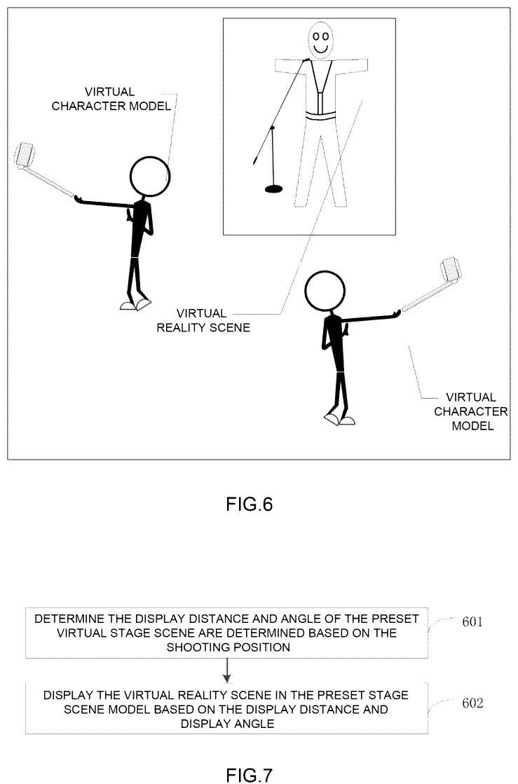

As mentioned above, the virtual reality scene displayed in the virtual reality scene is actually limited by the shooting position of the virtual character model in the virtual reality space. The captured image information during selfie is generated from the virtual reality scene visible at the shooting position, as shown in FIG. 6. If the shooting position of the virtual character model in the virtual reality space is different, the virtual reality scene seen will be different.

Therefore, how to display virtual reality scenes in the preset stage scene model based on the shooting position is crucial for the realistic experience of selfies.

It should be noted that in different application scenarios, the way virtual reality scenes are displayed in the preset stage scene model varies depending on the shooting position, as shown in the following examples:

In an embodiment of the present disclosure, as shown in FIG. 7, a virtual reality scene is displayed in a preset stage scene model based on the shooting position.

At step 701, the display distance and angle of the preset virtual stage scene are determined based on the shooting position.

In some possible embodiments, the shooting position comprises the first coordinate information in the virtual reality space. In this embodiment, the second coordinate information of the preset virtual stage scene is determined, and the display distance and display angle can be computed based on the first and second coordinate information.

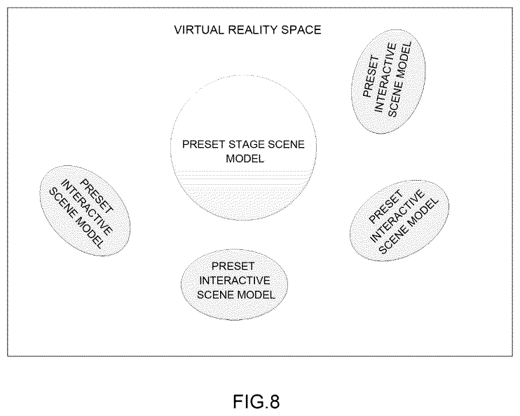

In other possible embodiments, if the virtual reality space includes at least one preset interactive scene model in addition to the preset stage scene model, as shown in FIG. 8, for the virtual concert scene, in order to enhance the realism of the concert scene, in addition to building a stage scene model, multiple interactive scene models are also built, and the virtual character model is active in the interactive scene model, Equivalent to the audience located in the audience seat.

It is to be understood that the display distance and display angle of virtual reality scenes observed by users in different interactive scene models are different, but the display distance and display angle of virtual reality scenes observed in the same interactive scene model are roughly the same. Therefore, in an embodiment of the present disclosure, the target preset interactive scene model at the shooting position is determined, and the preset database is queried to obtain the display distance and display angle that match the target preset interactive scene model.

At step 702, the virtual reality scene is displayed in the preset stage scene model based on the display distance and display angle.

In an embodiment of the present disclosure, after determining the display content and display angle, a virtual reality scene is displayed in a preset stage scene model based on the display distance and display angle.

In some possible embodiments, the closer the virtual reality scene is in real space, the smaller the range of the virtual reality scene seen and the larger the display size. Therefore, in this embodiment, the display scaling ratio of the virtual reality scene is determined based on the display distance, where the smaller the display distance, the larger the corresponding display scaling ratio. The specific calculation method for scaling ratio can be determined based on the preset shooting parameters of the camera model, such as the preset shooting field angle and imaging size. This calculation method can refer to the imaging principle of “near big far small” when shooting with a camera in reality. In this embodiment, the display range is determined based on the display angle, that is, the screen content of the virtual reality scene within the maximum range that can be presented is determined based on the display angle, and the virtual reality scene is displayed in the preset stage scene model according to the display scaling ratio and display range.

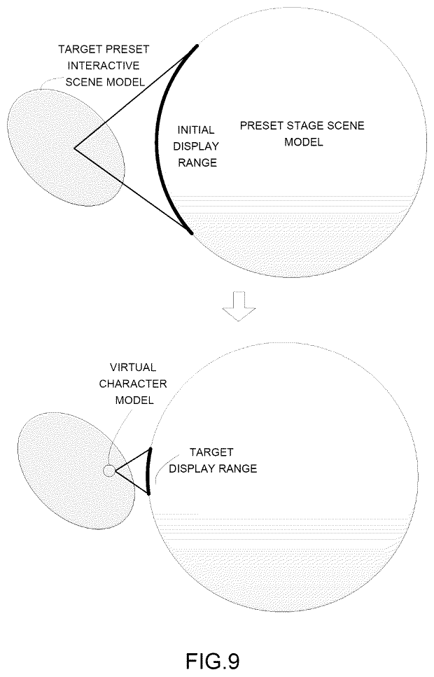

In this embodiment, in order to achieve refined rendering of viewfinder information, the initial display range of the virtual reality scene can be determined based on the display angle determined by the target preset interactive scene model, as shown in FIG. 9. This initial display range can be understood as the maximum presentable display range under the target preset interactive scene model, and thus, the real-time distance between the virtual character model and the preset stage scene model can be determined, Determine the target display range in the initial display area based on real-time distance.

Furthermore, it can be understood that displaying virtual reality scenes in the preset stage scene model based on display distance and display angle is the maximum imagable range; therefore, the captured image information belongs to this imagable range.

In an embodiment of the present disclosure, the selfie field of view range of the camera model is determined, and then the virtual scene image information matched with the shooting field angle is determined, where the virtual scene image information includes virtual reality scenes and virtual character models within the selfie field of view range; the texture information corresponding to the virtual scene image information is rendered in the viewfinder area. In this embodiment, it is determined that the real-time texture information within the viewfinder area is captured image information.

In this embodiment, the selfie field of view range refers to the range that the user needs to shoot virtual reality scenes during the VR video viewing process. For this embodiment, relevant parameters for controlling the shooting range of the camera can be pre-set, such as field of view angle (FOV) and other parameters. The field of view for this selfie can be adjusted according to the user's needs, in order to capture the required photos or videos.

The virtual scene screen information may include virtual scene content that can be seen within the shooting range. As the shooting is within the selfie field of view, the virtual scene screen information includes virtual reality scenes and virtual character models within the selfie field of view.

The virtual scene image information can be rendered to texture (RTT) by using Unity's Camera tool to select the scene information corresponding to the shooting range of the camera model in the virtual reality scene. Then, the rendered texture map is placed within the preset viewfinder area of the camera model, thereby achieving the display of virtual scene image information within the preset viewfinder area of the camera model.

The viewfinder area can be pre-set according to actual needs, with the aim of allowing users to preview the effect of the selected scene information map before confirming shooting.

For example, the 3D spatial position of the camera model and the 3D spatial position of the user's own virtual character model are bound in advance, the current 3D spatial position displayed by the camera model is determined based on the real-time 3D spatial position of the user's own virtual character model, and then the camera model is displayed based on this position to present the effect of the user using the camera. The effect of presenting the user's own virtual character holding a selfie stick camera. The viewfinder can be the display screen position of the selfie camera, and the rendered texture map can be placed within the viewfinder area to simulate a preview effect similar to that of a real camera before shooting.

Unlike the prior art, this virtual shooting method in this embodiment involves real-time rendering of VR virtual scene information within the selected range to textures, and then pasting it into the area of the viewfinder without the need for sensors in the physical camera module, thus ensuring the image quality of the captured image. Moreover, during the movement of the camera, the VR scene content within the dynamic moving shooting range can be presented in real-time within the preset viewfinder area, and the display effect of the viewfinder screen will not be affected by factors such as camera swing. This can effectively simulate the user's real shooting experience, thereby improving the user's VR user experience.

If the user selects a photo service, the VR device can use the real-time single map information in the viewfinder area as the photo information taken by the user upon receiving the user's confirmation to take the photo. If the user selects a video recording service, the VR device can record real-time texture information in the viewfinder area as video frame data upon receiving the user's confirmation of the shooting command. When the user confirms the completion of the shooting, the recording is stopped, and recorded video information is generated based on the video frame data recorded during this period.

In the actual shooting process, if users need to capture selfie image information within their expected shooting range, they can dynamically adjust the selfie field of view of the camera model by inputting the adjustment command of the shooting range.

There are multiple optional ways for users to input the call command for the selfie function. As one of the options, the call command for the selfie function can be input through user gestures. Correspondingly, on the VR device side, the camera can first recognize the image information captured by the user and obtain the user gesture information. Then the user's gesture information is matched with the preset gesture information, where different preset gesture information has corresponding preset adjustment instructions (used to adjust the camera's selfie field of view). Furthermore, the preset adjustment instructions corresponding to the matched preset gesture information can be obtained as the adjustment instructions for the selfie field of view.

For example, when a user moves their hand to the left, or to the right, or up, or down, or up, or down, or to the left, or down, etc., it can trigger the camera model and its selfie field of view to follow the movement to the left, or to the right, or up, or down, or up, or down, or left; Moving the user's hand forward or backward can trigger the adjustment of the camera tool's shooting focal length; The user's hand rotation can trigger the camera model and its selfie field of view to follow the rotation. Through this optional method, it is convenient for users to control shooting and improve shooting efficiency.

As another option, the call command for the input shooting function can be implemented through the interactive component model. Correspondingly, on the VR device side, at least one interactive component model can be first displayed in the virtual reality space, where each interactive component model corresponds to a preset command for adjusting the shooting range, such as displaying interactive component models that represent moving in the four directions of up, down, left, right, and showing camera rotation Interactive component model for adjusting focal length; Then, by identifying the image information captured by the camera on the user, the position of the user's hand or handheld device is obtained and mapped to the virtual reality space, and then the click mark space position of the user's hand or handheld device is determined; If the spatial position of the click mark matches the spatial position of the target interaction component model in these interaction component models representing the adjustment of the selfie field of view range, the target interaction component model will correspond to the preset command for adjusting the selfie field of view range as the adjustment command for the selfie field of view range of the camera.

For example, if the spatial position of the click mark on the user's hand or handheld device matches the spatial position of the “left” interaction component model, it can trigger the camera model and its selfie field of view to follow the left movement; If the spatial position of the click mark on the user's hand or handheld device matches the spatial position of the “turn left” interaction component model, it can trigger the camera model and its selfie field of view to follow the left rotation. Through this optional method, there is no need for physical device button control, which can avoid the impact of user control caused by the easy damage of physical device buttons.

As another option, the call command for input shooting function can be achieved by manipulating a device. Correspondingly, on the VR device side, the adjustment command for the selfie field of view sent by the manipulating device can be received; And/or, by identifying the image information captured by the camera on the control device, determine the spatial position change of the control device, and adjust the camera's selfie field of view range based on the spatial position change of the control device.

For example, the control device can be a handheld controller device held by the user, which binds the shooting range of the camera frame to the controller, and the user moves/rotates the controller to view; By pushing the joystick back and forth, the focal length of the viewfinder can be adjusted. In addition, physical buttons for up, down, left, right, and rotation control can also be preset on the controller device, allowing users to directly adjust the selfie field of view of the camera through these physical buttons.

In order to guide users on how to adjust the selfie field of view range of the camera model, this embodiment method may optionally comprise: outputting guidance information on adjusting the selfie field of view range. For example, guidance information such as “pushing the joystick back and forth to adjust the focal length”, “pressing the B key to exit shooting”, and “pressing the trigger key to take photos” can be provided to assist users in shooting operations, which improves the efficiency of users in adjusting the selfie field of view range of the camera model and other shooting related operations.

Based on the dynamic adjustment of the spatial position of the camera model, the camera model is displayed in motion, and the real-time rendered texture map is placed in the preset viewfinder area of the camera model. In this embodiment, during the movement of the camera, the VR scene content within the dynamic moving shooting range can be presented in real-time within the preset viewfinder area, and the display effect of the viewfinder screen will not be affected by factors such as camera swing. This can effectively simulate the user's real selfie experience, thereby improving the user's VR user experience.

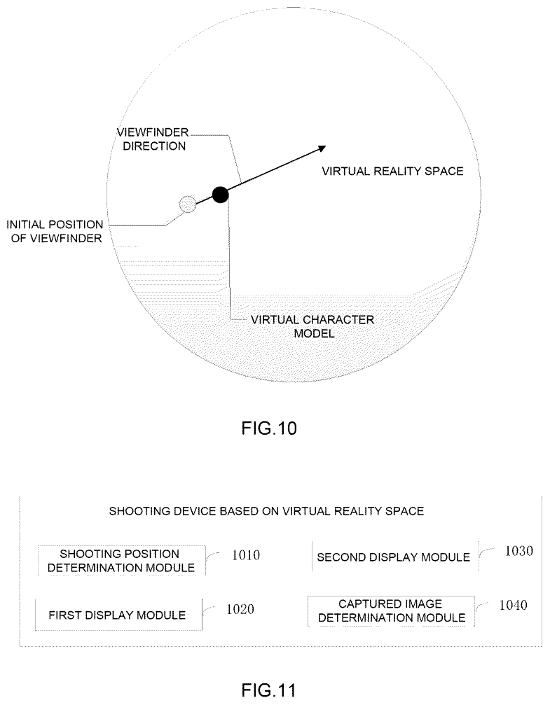

It should be noted that in the aforementioned embodiments of the present disclosure, in order to ensure that a selfie angle image appears in the viewfinder area of the camera model, as shown in FIG. 10, the real-time viewfinder information faces the virtual character model in the viewfinder direction, and the initial position of the viewfinder is located at a preset distance from the front of the virtual character model. The preset distance can be calibrated based on experimental data, usually corresponding to the distance between the virtual camera model and the virtual character model.

In summary, the shooting method based on virtual reality space in an embodiment of the present disclosure presents real-time viewfinder information within the selfie duration range, facilitating users to determine the operation through selfie and determine the real-time viewfinder information within the viewfinder area as the captured image information. This enables users in the dashed reality environment to experience the feeling of using a camera to selfie in a real environment, improving their VR user experience.

In order to achieve the above embodiments, this disclosure also proposes a shooting device based on virtual reality space. FIG. 11 is a structural schematic diagram of a virtual reality space-based shooting device provided in embodiments of the present disclosure. The device can be implemented by software and/or hardware and can generally be integrated into electronic devices for virtual reality space-based shooting. As shown in FIG. 11, the device includes a shooting position determination module 1010, a first display module 1020, a second display module 1030, and a shooting image determination module 1040, wherein,

The shooting position determination module 1010 is used to determine the shooting position of the virtual character model holding the camera model in virtual reality space in response to the selfie call command;

The first display module 1020 is configured to display virtual reality scenes in a preset stage scene model based on the shooting position;

The second display module 1030 is configured to display real-time viewfinder information within the viewfinder area of the camera model, wherein the real-time viewfinder information includes virtual reality scenes and virtual character models within the selfie field of view;

The captured image determination module 1040 is configured to determine the real-time viewfinder information within the viewfinder area as captured image information in response to the selfie confirmation command.

The shooting device based on virtual reality space provided in embodiments of the present disclosure can execute the shooting method based on virtual reality space provided in any of embodiments of the present disclosure, and has corresponding functional modules and beneficial effects for the execution method. The implementation principle is similar and will not be repeated here.

In order to implement the above embodiments, it is also provided a computer program product comprising a computer program/instructions implementing the virtual reality space-based shooting method in the above embodiment when executed by the processor.

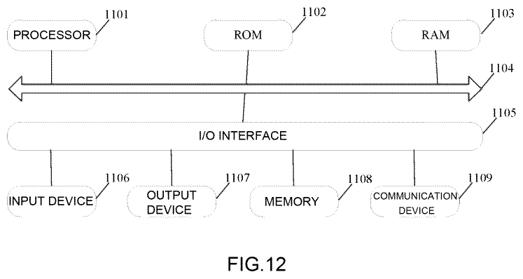

FIG. 12 is a schematic diagram of the structure of an electronic device provided in embodiments of the present disclosure.

FIG. 12 shows a structural schematic diagram suitable for implementing the electronic device 1100 in an embodiment of the present disclosure. The electronic device 1100 in embodiments of the present disclosure may include, but is not limited to, mobile terminals such as mobile phones, laptops, digital broadcasting receivers, PDAs (personal digital assistants), PADs (tablets), PMPs (portable multimedia players), car terminals (such as car navigation terminals), and fixed terminals such as digital TVs, desktop computers, and the like. The electronic device shown in FIG. 12 is only an example and should not impose any limitations on the functionality and scope of use of embodiments of the present disclosure.

As shown in FIG. 12, electronic device 1100 may include a processor (such as a central processing unit, graphics processor, etc.) 1101, which may perform various appropriate actions and processes based on programs stored in read-only memory (ROM) 1102 or loaded from memory 1108 into random access memory (RAM) 1103. In RAM 1103, various programs and data required for the operation of electronic device 1100 are also stored. Processor 1101, ROM 1102, and RAM 1103 are connected to each other through bus 1104. The input/output (I/O) interface 1105 is also connected to bus 1104.

Typically, the following devices can be connected to I/O interface 1105: input devices 1106 including such as touch screens, touchpads, keyboards, mice, cameras, microphones, accelerometers, gyroscopes, etc.; output devices 1107 including, e.g., liquid crystal displays (LCDs), speakers, vibrators, etc. memory 1108 including, e.g., magnetic tapes, hard drives, etc.; and communication device 1109. Communication device 1109 can allow electronic device 1100 to communicate wirelessly or wirelessly with other devices to exchange data. Although FIG. 12 illustrates electronic device 1100 with various devices, it should be understood that it is not required to implement or possess all the illustrated devices. Can be implemented alternatively or have more or fewer devices.

Specifically, according to embodiments of the present disclosures, the process described above with reference to the flowchart can be implemented as a computer software program. For example, an embodiment of the present disclosure includes a computer program product that includes a computer program carried on a non-transient computer-readable medium, which includes program code for executing the method shown in the flowchart. In such embodiments, the computer program can be downloaded and installed from the network through communication device 1109, installed from memory 1108, or installed from ROM 1102. When the computer program is executed by processor 1101, the above-mentioned functions defined in the virtual reality space-based shooting method of embodiments of the present disclosure are executed.

It should be noted that the computer-readable medium mentioned in this disclosure can be a computer-readable signal medium, a computer-readable storage medium, or any combination of the two. Computer readable storage media can be, for example, but not limited to, systems, devices or devices of electricity, magnetism, light, electromagnetism, infrared, or semiconductors, or any combination of the above. More specific examples of computer-readable storage media may include but are not limited to: electrical connections with one or more wires, portable computer disks, hard drives, random access memory (RAM), read-only memory (ROM), erasable programmable read-only memory (EPROM or flash memory), optical fibers, portable compact disk read-only memory (CD-ROM), optical storage devices, magnetic storage devices Or any suitable combination of the above. In this disclosure, a computer-readable storage medium may be any tangible medium that contains or stores a program, which can be used by or in combination with an instruction execution system, device, or device. In this disclosure, computer-readable signal media may include data signals propagated in the baseband or as part of the carrier wave, which carry computer-readable program code. This propagation of data signals can take various forms, including but not limited to electromagnetic signals, optical signals, or any suitable combination of the above. A computer-readable signal medium can also be any computer-readable medium other than a computer-readable storage medium, which can send, propagate, or transmit programs for use by or in combination with instruction execution systems, devices, or devices. The program code contained on computer readable media can be transmitted using any suitable medium, including but not limited to: wires, optical cables, RF (radio frequency), etc., or any suitable combination of the above.

In some implementations, clients and servers can communicate using any currently known or future developed network protocol such as HTTP (Hyper Text Transfer Protocol), and can interconnect with any form or medium of digital data communication (such as communication networks). Examples of communication networks include local area networks (“LANs”), wide area networks (“WANs”), internets (such as the Internet), and end-to-end networks (such as ad hoc end-to-end networks), as well as any currently known or future developed networks.

The computer readable medium mentioned above can be included in the electronic device mentioned above; It can also exist separately without being assembled into the electronic device.

The computer readable medium mentioned above carries one or more programs, and when the above one or more programs are executed by the electronic device, the electronic device:

In response to a selfie call command, determines the shooting position of the virtual character model holding the camera model in the virtual reality space, and displays the virtual reality scene in the preset stage scene model based on the shooting position; displays real-time viewfinder information in the viewfinder area of the camera model, including virtual reality scenes and virtual character models within the selfie field of view; in response to a selfie confirmation command, determines the real-time viewfinder information within the viewfinder area as the captured image information. As a result, selfie in virtual space is achieved, expanding the shooting methods in virtual space, and improving the realism of shooting in virtual space.

Electronic devices may write computer program code for performing the operations disclosed in this disclosure in one or more programming languages or combinations thereof, including but not limited to object-oriented programming languages such as Java, Smalltalk, C++, as well as conventional procedural programming languages such as “C” or similar programming languages. Program code can be completely executed on the user's computer, partially executed on the user's computer, executed as a standalone software package, partially executed on the user's computer, partially executed on a remote computer, or completely executed on a remote computer or server. In cases involving remote computers, the remote computer can be connected to the user's computer through any type of network, including a local area network (LAN) or wide area network (WAN), or can be connected to an external computer (such as using an Internet service provider to connect through the Internet).

The flowchart and block diagram in the attached figure illustrate the possible architecture, functions, and operations of systems, methods, and computer program products according to various embodiments of the present disclosure. At this point, each box in a flowchart or block diagram can represent a module, program segment, or part of code that contains one or more executable instructions for implementing specified logical functions. It should also be noted that in some alternative implementations, the functions indicated in the boxes can also occur in a different order than those indicated in the accompanying drawings. For example, two consecutive boxes can actually be executed in parallel, and sometimes they can also be executed in the opposite order, depending on the function involved. It should also be noted that each box in the block diagram and/or flowchart, as well as the combination of boxes in the block diagram and/or flowchart, can be implemented using dedicated hardware-based systems that perform specified functions or operations, or can be implemented using a combination of dedicated hardware and computer instructions.

The units described in embodiments of the present disclosure can be implemented through software or hardware. In some cases, the name of a unit does not constitute a qualification for the unit itself.

The functions described above in this article can be at least partially executed by one or more hardware logic components. For example, non-limiting examples of hardware logic components that can be used include: Field Programmable Gate Arrays (FPGAs), Application Specific Integrated Circuits (ASICs), Application Specific Standard Products (ASSPs), On Chip Systems (SOC), Complex Programmable Logic Devices (CPLDs), and so on.

In the context of this disclosure, machine readable media can be tangible media that can contain or store programs for use by or in combination with instruction execution systems, devices, or devices. Machine readable media can be machine readable signal media or machine-readable storage media. Machine readable media may include but are not limited to electronic, magnetic, optical, electromagnetic, infrared, or semiconductor systems, devices, or devices, or any suitable combination of the above. More specific examples of machine-readable storage media may include electrical connections based on one or more wires, portable computer disks, hard drives, random access memory (RAM), read-only memory (ROM), erasable programmable read-only memory (EPROM or flash memory), optical fiber, portable compact disc read-only memory (CD-ROM), optical storage devices, magnetic storage devices, or any suitable combination of the above.

The above description is only a preferred embodiment of this disclosure and an explanation of the technical principles used. Those skilled in the art should understand that the scope of disclosure referred to in this disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in this disclosure.

Furthermore, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of this disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims.

I/We claim:

1. A shooting method based on virtual reality space, comprising:
in response to a selfie call command, determining a shooting position of a virtual character model that holds the camera model in the virtual reality space, and displaying a virtual reality scene in a preset stage scene model based on the shooting position;
displaying real-time viewfinder information within the viewfinder area of the camera model, wherein the real-time viewfinder information comprises a virtual reality scene and a virtual character model within the selfie field of view; and
in response to a selfie confirmation command, determining the real-time viewfinder information within the viewfinder area as captured image information.

2. The shooting method according to claim 1, wherein the displaying a virtual reality scene in a preset stage scene model based on the shooting position comprising:
determining a display distance and a display angle with respect to the preset virtual stage scene based on the shooting position; and
displaying a virtual reality scene in the preset stage scene model based on the display distance and the display angle.

3. The shooting method according to claim 2, wherein the determining a display distance and a display angle with respect to the preset virtual stage scene based on the shooting position comprises:
determining a target preset interactive scene model where the shooting position is located; and
querying a preset database to obtain the display distance and display angle that match the target preset interactive scene model.

4. The shooting method according to claim 3, wherein the displaying a virtual reality scene in the preset stage scene model based on the display distance and the display angle comprises:
determining a display range of the virtual reality scene based on the display angle;
determining a display zoom ratio based on the display distance; and
displaying virtual reality scenes within the display range in the preset stage scene model according to the display scaling ratio.

5. The shooting method according to claim 1, wherein the displaying real-time viewfinder information within the viewfinder area of the camera model comprising:
determining a selfie field of view range of the camera model;
determining virtual scene image information that matches the shooting field angle, wherein the virtual scene image information comprises a virtual reality scene and a virtual character model within the selfie field range; and
rendering texture information corresponding to the virtual scene image information in the viewfinder area.

6. The shooting method according to claim 5, wherein the determining the real-time viewfinder information within the viewfinder area as captured image information comprises:
determining the real-time texture information within the viewfinder area as the captured image information.

7. The shooting method according to claim 1, wherein in response to a selfie confirmation command, the determining the real-time viewfinder information within the viewfinder area as captured image information comprises:
determining the selfie field of view range in response to a selfie field of view range adjustment command; and
displaying real-time viewfinder information corresponding to the adjusted selfie field of view within the viewfinder area of the camera model.

8. The shooting method according to claim 7, wherein in response to a selfie field of view range adjustment command comprises at least one of:
in response to an adjustment instruction for a shooting position of the camera model in the virtual reality space; or
in response to an adjustment command for a preset shooting focal length.

9. An electronic device, wherein the electronic device comprises:
a processor; and
a memory for storing instructions executable by the processor;
the processor is configured to read the executable instructions from the memory and execute the executable instructions to implement a shooting method based on virtual reality space, the shooting method comprising:
in response to a selfie call command, determining a shooting position of a virtual character model that holds the camera model in the virtual reality space, and displaying a virtual reality scene in a preset stage scene model based on the shooting position;
displaying real-time viewfinder information within the viewfinder area of the camera model, wherein the real-time viewfinder information comprises a virtual reality scene and a virtual character model within the selfie field of view; and
in response to a selfie confirmation command, determining the real-time viewfinder information within the viewfinder area as captured image information.

10. The electronic device according to claim 9, wherein the displaying a virtual reality scene in a preset stage scene model based on the shooting position comprising:
determining a display distance and a display angle with respect to the preset virtual stage scene based on the shooting position; and
displaying a virtual reality scene in the preset stage scene model based on the display distance and the display angle.

11. The electronic device according to claim 10, wherein the determining a display distance and a display angle with respect to the preset virtual stage scene based on the shooting position comprises:
determining a target preset interactive scene model where the shooting position is located; and
querying a preset database to obtain the display distance and display angle that match the target preset interactive scene model.

12. The electronic device according to claim 11, wherein the displaying a virtual reality scene in the preset stage scene model based on the display distance and the display angle comprises:
determining a display range of the virtual reality scene based on the display angle;
determining a display zoom ratio based on the display distance; and
displaying virtual reality scenes within the display range in the preset stage scene model according to the display scaling ratio.

13. The electronic device according to claim 9, wherein the displaying real-time viewfinder information within the viewfinder area of the camera model comprising:
determining a selfie field of view range of the camera model;
determining virtual scene image information that matches the shooting field angle, wherein the virtual scene image information comprises a virtual reality scene and a virtual character model within the selfie field range; and
rendering texture information corresponding to the virtual scene image information in the viewfinder area.

14. The electronic device according to claim 9, wherein the determining the real-time viewfinder information within the viewfinder area as captured image information comprises:
determining the real-time texture information within the viewfinder area as the captured image information.

15. The electronic device according to claim 9, wherein in response to a selfie confirmation command, the determining the real-time viewfinder information within the viewfinder area as captured image information comprises:
determining the selfie field of view range in response to a selfie field of view range adjustment command; and
displaying real-time viewfinder information corresponding to the adjusted selfie field of view within the viewfinder area of the camera model.

16. The electronic device according to claim 9, wherein in response to a selfie field of view range adjustment command comprises at least one of:
in response to an adjustment instruction for a shooting position of the camera model in the virtual reality space; or
in response to an adjustment command for a preset shooting focal length.

17. A computer-readable storage medium, wherein the computer-readable storage medium stores a computer program for executing a shooting method based on a virtual reality space, the shooting method comprising:
in response to a selfie call command, determining a shooting position of a virtual character model that holds the camera model in the virtual reality space, and displaying a virtual reality scene in a preset stage scene model based on the shooting position;
displaying real-time viewfinder information within the viewfinder area of the camera model, wherein the real-time viewfinder information comprises a virtual reality scene and a virtual character model within the selfie field of view; and
in response to a selfie confirmation command, determining the real-time viewfinder information within the viewfinder area as captured image information.

18. The computer-readable storage medium according to claim 17, wherein the displaying a virtual reality scene in a preset stage scene model based on the shooting position comprising:
determining a display distance and a display angle with respect to the preset virtual stage scene based on the shooting position; and
displaying a virtual reality scene in the preset stage scene model based on the display distance and the display angle.

19. The computer-readable storage medium according to claim 17, wherein the displaying real-time viewfinder information within the viewfinder area of the camera model comprising:
determining a selfie field of view range of the camera model;
determining virtual scene image information that matches the shooting field angle, wherein the virtual scene image information comprises a virtual reality scene and a virtual character model within the selfie field range; and
rendering texture information corresponding to the virtual scene image information in the viewfinder area.

20. The computer-readable storage medium according to claim 17, wherein in response to a selfie confirmation command, the determining the real-time viewfinder information within the viewfinder area as captured image information comprises:
determining the selfie field of view range in response to a selfie field of view range adjustment command; and
displaying real-time viewfinder information corresponding to the adjusted selfie field of view within the viewfinder area of the camera model.
